(19) United States
(12) Patent Application Publication
(10) Pub. No.: US 2006/0062131 A1
(43) Pub. Date: Mar. 23, 2006

(54) OPTICAL INFORMATION RECORDING MEDIUM AND PRODUCTION METHOD OF THE SAME

(76) Inventors: Kenichi Nagata, Nishinomiya (JP); Kenichi Nishiuchi, Hirakata (JP)

Correspondence Address: WENDEROTH, LIND & PONACK, L.L.P., 2033 K STREET N. W., SUITE 800, WASHINGTON, DC, 20006-1021, US

(21) Appl. No.: 10/532,061

(22) PCT Filed: Oct. 24, 2003
(86) PCT No.: PCT/JP03/13600

§ 371 Date: Apr. 21, 2005

(30) Foreign Application Priority Data
Oct. 28, 2002 (JP) 2002-312437

(51) Int. Cl. G11B 7/24

(52) U.S. Cl. 369/275.1; 369/275.3; 369/272.1

(57) ABSTRACT

In a single-sided multi-layer optical disk, “n” information layers are formed so that sector address portions (9, 11) do not overlap with each other in a stack direction in a combination of adjacent information layers (1, 4) and an optical separating layer (3) is disposed between the information layers. Thereby, signals of the sector address portion can be reproduced stably without being affected by the sector address portions of the adjacent information layer(s).

### TECHNICAL FIELD

The present invention is related to an optical information recording medium on and from which large volume data is recorded and reproduced using a laser beam and a method for producing the optical information recording medium.

### BACKGROUND OF THE INVENTION

There is a phase-change type optical disk as an optical information recording medium in or from which a signal is recorded and reproduced by a laser beam. In the phase-change type optical disk in and from which the signal is repeatedly recorded and reproduced, a chalcogenide is generally employed as a material for a recording layer.

Further, an optical disk of a single-sided dual-layer structure is proposed for the purpose of increasing recording capacity of a writable optical disk or a writable and erasable (that is, an overwritable) phase-change type optical disk (see, for example, Japanese Patent Kokai (Laid-Open) Publication No. 2000-36130).

Signals may be recorded on the optical disk according to a format wherein a sector structure having sector address portions is employed or a continuous recording format. In the optical disk of the sector structure, an area for managing an information signal to be recorded and a data area wherein the information signal is recorded by a user are separated.

In the case where the sector structure is applied to a single-sided multi-layer medium having two or more recording layers, there is a problem that a reproduced signal from an information layer is deformed depending on the recorded state of another information layer adjacent to the information layer. In other words, the signal amplitude and the signal level of the reproduced signal depends on whether a signal is recorded on the adjacent recording layer(s). In addition, there is also a problem that the reproduced waveform is deformed at a boarder between the sector address portion and the data area of the adjacent information layer(s) since the sector address portion is always unrecorded and the signal is recorded only on the data area. However, in practical use, error correction allows the information recorded on the data area to be reproduced without being problematically affected by the sector address portion of the adjacent information layer(s). On the other hand, since the error correction for the reproduction of the information from the sector address portion is weak, the reproduced information is directly affected by the adjacent sector address portion. That is, in the single-sided multi-layer medium, the problem tends to be caused in the practical use due to the error of the reproduction of the information from the address portion.

For the purpose of resolving this problem, there is disclosed a solution wherein the sector address portions of each information layer are completely overlapped in a stacked direction and an amount of dislocation between the sector address portions is detected and corrected even if the overlapped sector address portions are dislocated (see, for example, WO00/23990). However, the complete overlap of the sector address portions is more time-consuming and requires more costs upon producing the optical information recording medium and it does not give a substantial resolution to the problem that the peripheral boundary region of the sector address portion affects the adjacent information layer(s) (especially the sector address portion(s)). On the other hand, the detection and correction of the amount of dislocation between the section address portions requires a complicated recording and reproducing apparatus, resulting in another problem of cost rise.

### DISCLOSURE OF INVENTION

The main object of the present invention is to provide an optical information recording medium of a single-sided multi-layer structure which resolves the problem, that is an optical information recording medium from which information of an sector address portion is reproduced without being affected by the adjacent information layer(s) and to provide a method for producing such an optical information recording medium.

The present invention provides a single-sided multi-layer optical information recording medium including a substrate and “n” (n≧2) information layers which are formed on the substrate and on and from which a signal can be recorded and reproduced by a laser beam that is applied through the substrate, wherein an optical separating layer is formed between the information layers, each of the information layers has a sector structure having sector address portions and data areas for recording information signals, the sector address portion and the data area are divided in a circumferential direction, and the sector address portions of each information layer do not overlap with at least the sector address portions of the adjacent information layer(s) in a direction of stack of information layers.

The “information layer” refers to a layer which includes at least a recording layer where a recorded mark is formed by irradiation of a laser beam. The “optical separating layer” refers to a layer which is provided in order to separate the information layers with a distance therebetween so that when the information signal is recorded on or reproduced from any one of “n” information layers, the laser beam is not focused on another information layer. That is, the optical separating layer is a layer which is provided so that the signal is not recorded on or reproduced from two or more information layers by the laser beam at the same time upon recording the signal on or reproducing the signal from each information layer.

Herein, “the sector address portions of each information layer do not overlap with at least the sector address portions of the adjacent information layer(s)” means that when a section is viewed taken along one sector address portion in a direction of stack of information layers (that is, a thickness direction of the medium), no sector address portions (including boundary lines thereof) are seen in information layers that are adjacent above and below to the one sector address portion. Therefore, when “n”=2, any of the sector address portions in one of the information layers do not overlap with the sector address portions in the other information layer. When “n”=3, any of the sector address portions in the middle information layer do not overlap with the sector address portions in the upper and lower information layers, but the sector address portions in the upper information layer may overlap with the sector address portions in the lower information layer that is not adjacent to the upper information layer.

This construction enables information on a sector address portion of a certain information layer to be reproduced without being affected by other sector address portions of another information layer(s) that is adjacent to the certain information layer. This reduces the deformation of reproduced signals from the sector address portions, whereby the object of the present invention can be achieved.

It is preferable that the sector address portions of each information layer do not overlap with the sector address portions of any of the other information layers in the direction of stack of information layers. That is, when a section is viewed taken along one sector address portion of the direction of stack of information layers, no sector address portions (including boundary lines thereof) other than the one sector portions are preferably seen in the other information layers. Such a construction reduces deformation of reproduced signals of the sector address portions of a certain information layer by eliminating the affect of the sector address portions not only in the adjacent information layer(s) but also in other information layers which are far from the certain information layer. Assumed that an optical information recording medium of this construction is entirely transparent except for the sector address portions, all the sector address portions can be seen when it is viewed from the above side. When “n”=2, this construction is necessarily obtained. When “n”=3, any of the sector address portions of the middle information layer do not overlap with the sector address portions of the upper and lower information layers, and preferably the sector address portions of the upper information layer do not overlap with the sector address portions of the lower information layer.

The present invention also provides a method for producing an optical information recording medium including a substrate and “n” (n≧2) information layers which are formed on the substrate and on and from which layers a signal can be recorded and reproduced by a laser beam that is applied through the substrate, which method includes:

forming the information layer which has a sector structure having sector address portions and data areas for recording information signals, the sector address portion and the data area being divided in a circumferential direction;

forming an optical separating layer which is to be disposed between the information layers; and

positioning the sector address portions of each information layer so that they do not overlap with at least the sector address portions of the information layer(s) that is adjacent to the each information layer in a direction of stack of information layers. An optical recording medium produced according to this method is the optical recording medium of the present invention.

“Positioning the sector address portions of each information layer so that they do not overlap with at least the sector address portions of the information layer(s) that is adjacent to the each information layer” is easier than overlapping the sector address portions completely. Therefore, this invention makes it possible to produce the optical information recording medium which can realize small deformation of reproduced signals from the sector address portions by the method which is more easily carried out than the conventional method.

In the production method of the present invention, the information layer having the sector structure may be formed by forming a recording layer and other layers which constitute the information layer on a surface of the substrate or the optical separating layer which has concaves and convexities which correspond to the sector structure so that the recording layer and the other layers conform the concaves and convexities.

Positioning may be previously carried out based on the number of the information layers and the sector structure. Alternatively, positioning may be carried out on site by, for example, rotating the information layer to be stacked, looking at the positions of the sector address portions upon stacking the information layers successively. Alternatively, a preliminary positioning may be carried out followed by fine adjustment of the information layers on site to complete positioning.

### BRIEF DESCRIPTION OF THE DRAWINGS

FIG. 1 is a schematic view showing a structure of an embodiment of an optical information recording medium of a single-sided dual-layer structure according to the present invention;

FIG. 2 is a schematic view showing each step of an embodiment of a method for producing an optical information recording medium of a single-sided dual-layer structure;

FIG. 3 is a schematic view showing each step of another embodiment of a method for producing an optical information recording medium of a single-sided dual-layer structure; and

FIG. 4 is a schematic view showing a more specific structure of a first and a second information layers of the optical information recording medium shown in FIG. 1.

### DETAILED DESCRIPTION OF THE PREFERRED EMBODIMENTS

Embodiments of the present invention are described with reference to the drawings.

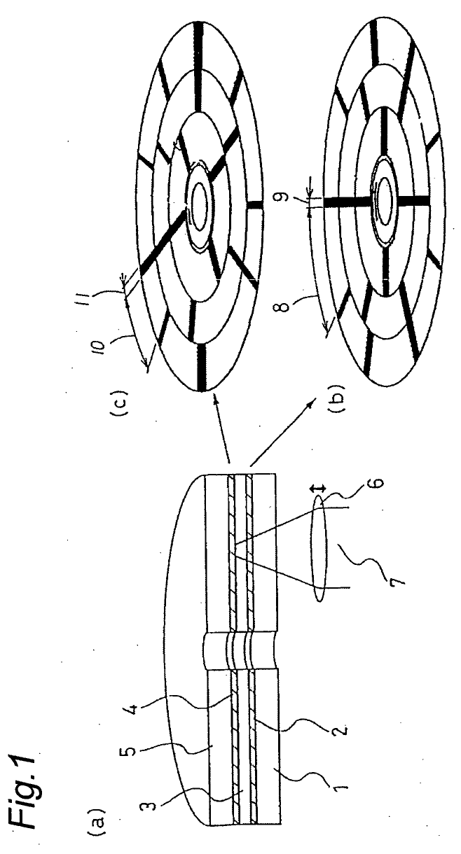

FIG. 1 shows a construction of an embodiment of an optical information recording medium (an optical disk) according to the present invention. FIG. 1(a) is a cross-sectional view taken along a radius. As shown in FIG. 1(a), this optical information recording medium includes a first information layer 2 and a second information layer 3 formed on a substrate 1, an optical separating layer 3 situated between the first information layer 2 and the second information layer 4, and a protective substrate 5. Recording and reproducing information signals may be carried out using a laser beam 7 which is applied from the side of the substrate 1 and focused by an objective lens 6. Information is recorded on and reproduced from the first information layer 2 by the laser beam 7 which passes through the substrate 1. Information is recorded on and reproduced from the second information layer 4 by the laser beam 7 which further passes through the first information layer 2.

FIGS. 1(b) and 1(c) show the sector structures of the first information layer 2 and the second information layer 4 respectively. As shown in FIG. 1(b), the first information layer 2 includes data areas 8 for recording and reproducing information signals on a surface thereof and sector address portions 9 for managing the location of data to be recorded. The data area 8 has a guide groove for tracking or sample pits in the form of a spiral. The sector address portion 9 has address pit trains arranged in a pattern corresponding to address information. Generally, the guide groove and the address pits are obtained as a result of formation of the information layer along convexities and concavities formed on a surface of the substrate 1 or the optical separating layer 3. Therefore, in order to make the dimension, the shape, the number and the location of the guide groove as well as those of the address pits as desired, it is necessary to make or select the substrate 1 or the optical separating layer 3 which has convexities and concavities corresponding to the desired guide groove and the address pits and to form the first information layer on the surface having the convexities and concavities.

As shown in FIG. 1(c), the second information layer 4 has data areas 10 and sector address portions 11 similarly to the first information layer 2, and the pattern thereof (that is, the sector location and the number of sectors) is the same as that of the first information layer 2. The two information layers having the sector structure of the same pattern have the same surface shape (that is, the concavo-convex pattern formed by the pits and the guide groove) viewed from the incidence side of the laser beam 7. The sector structure of the second information layer 4 is given by the convexities and concavities on the surface of the protective substrate 5 or the optical separating layer 3.

In the optical information recording medium of this embodiment of the present invention, the first information layer 2 and the second information layer 4 are disposed so that the circumferential relative positions of them are totally out of alignment and any of the circumferential relative positions of sector address portions 9 does not correspond to (i.e. does not overlap with) any of the sector address portions 11, as shown in FIGS. 1(b) and 1(c). As described above, since the first and the second information layers 2 and 4 have the same sector address structure, the sector address portions of both information layers need to be positioned so that they are completely out of alignment and then these two information layers need to be laminated with the optical separating layer 3 interposed therebetween in order to achieve the illustrated disposition.

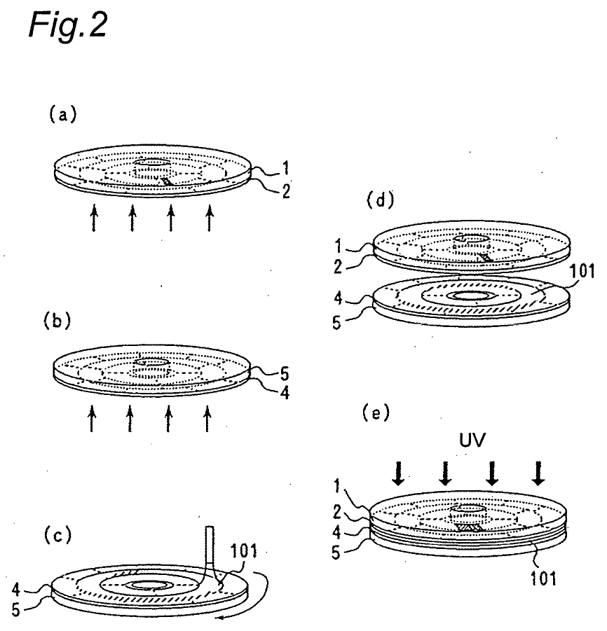

Next, a method for producing an optical information recording medium according to the present invention is described. FIG. 2 shows a method for producing an optical information recording medium of a single-sided dual-layer structure. In a first film formation step as shown in FIG. 2(a), a first information layer 2 is formed on a substrate 1 that has concavities and convexities corresponding to a guide groove of a sector structure that has sector address portions and data areas divided in a circumferential direction. Similarly, in a second film formation step as shown in FIG. 2(b), a second information layer 4 is formed on a second substrate 5. The second substrate 5 has convexities and concavities corresponding to a guide groove of a sector structure that has sector address portions and data areas divided in the circumferential direction similarly to the first substrate 1. The second substrate 5 becomes a protective substrate 5 in a final optical information recording medium. Further, in this production method, the first substrate 1 and the second substrate 5 are bonded together so that the second information layer 4 and the first information layer 2 are opposed to each other. For this reason, the concavities and convexities formed on the substrate 5 are complementary to the convexities and concavities formed on the first substrate 1. In other words, in the final optical recording medium, the concavity which constitutes the guide groove on the first substrate 1 overlaps with the concavity which constitutes the guide groove on the second substrate 5, whereby both of the first and the second information layers 2 and 4 form a groove face G that is nearer to the laser beam when viewed from incidence side of the laser beam.

In an application step as shown in FIG. 2(c), an adhesive 101 is applied on the second information layer 4. In this embodiment, a UV curable resin is employed as the adhesive. The application may be carried out by, for example, a spin coat method. The adhesive 101 becomes an optical separating layer 3 in the final optical information recording medium.

In a bonding step as shown in FIG. 2(d), the first information layer 2 on the first substrate 1 is opposed to and superposed on the second information layer 4 on the second protective substrate 5 through the adhesive 101. The sector address portions 9 of the first information layer 2 and the sector address portions 11 of the second information layer 4 may be previously positioned so that the sector address portions 9 do not overlap with the sector address portions 11 and then the superposition (or the overlapping) of these two layers may be carried out according to the positioning. More specifically, two information layers 1 and 4 may be superposed by moving horizontally one of two substrates 1 and 5 after the sector address portions 9 and 11 are opposed so as to satisfy the positional relationship wherein the sector address portions 9 do not overlap with the sector address portions 11. Alternatively, the superposition of two information layers may be carried out viewing the positions of the sector address portions 9 and 11, so that the sector address portions 9 do not overlap with the sector address portions 11. In other words, the positioning of the sector address portions 9 and 11 may be conducted on site at the time of superposing two information layers 2 and 4. The superposition on site may be carried out by, for example, rotating one or both of the first substrate 1 and the second substrate 5. The sector address portions 9 and 11 can be completely out of alignment by rotating one or both of the first substrate 1 and the second substrate 5 slightly from the condition wherein the sector address portions 9 and 11 are almost overlapped in the direction of stack of information layers.

In any positioning method is employed, the dislocation between the sector address portions 9 and 11 can be confirmed by, for example, examining visually the optical information recording medium wherein the two information layers 2 and 4 are superposed, from the incidence side of the laser beam. Since a light is reflected on the data area differently from on the sector address portion, existence of the sector address portions can be easily observed visually. For the illustrated optical information recording medium of a single-sided dual-layer structure, it can be confirmed that the sector address portions 9 and 10 are out of alignment in the stack direction, if the total number of the sector address portions determined visually is the total number of the sector address portions formed on two information layers 2 and 4.

In the bonding step, rotation or pressurization may be further conducted optionally, so that the thickness of the adhesiveness between the substrates is uniform.

Next, a hardening step as shown in FIG. 2(e) is carried out. The hardening step is carried out after the bonding step in which two information layers 2 and 4 are superposed in the positional relationship wherein the sector address portions 9 of the substrate 1 are relatively and completely dislocated in the circumferential direction from the sector address portions 11 of the substrate 2. In the illustrated embodiment, the adhesive 101 is hardened by applying a light of a UV lamp from the side of the first substrate 1.

By carrying out the above steps, an optical information recording medium of a single-sided dual-layer structure is obtained wherein dislocation of sector positions between two information layers is generated in the circumferential direction.

Another method for superposing two information layers formed on the substrates is a method wherein a resin sheet of round-shape is employed. In this method, the resin sheet of round-shape is used for separating the first information layer from the second information layer so as to produce an optical information recording medium of a single-sided dual-layer. In this method, a substrate and a protective substrate are bonded to the resin sheet disposing two information layers on both surfaces of the resin sheet so that the sector address portions of the first information layer are dislocated from the sector address portions of the second information layer. These two substrates having the information layers and the resin sheet are bonded together using a pressure-sensitive adhesive or a UV curable resin. More specifically, one of the substrates is bonded to the resin sheet and then the other substrate is bonded to the resin sheet by following the result of the preliminary positioning and/or by positioning on site so that two information layers are stacked.

The optical information recording medium of a single-sided dual-layer structure produced according to any one of the methods described above has an advantage that the signals obtained upon reproducing the sector address portions 9 have small or no deformation caused by the effect of the sector address portions of the information layer(s) adjacent to the sector address portions 9. Therefore, the signals recorded on this medium have a good reproducing characteristic and detection error is reduced or eliminated.

Next, a method wherein an optical separating layer is formed by a 2P (photo-polymerization) method is described as another embodiment of the production method of the present invention. In this production method, the sector structure of the second information layer is formed by imparting concavities and convexities to the surface of the optical separating layer using a stamper and forming the second information layer on the concavo-convex surface.

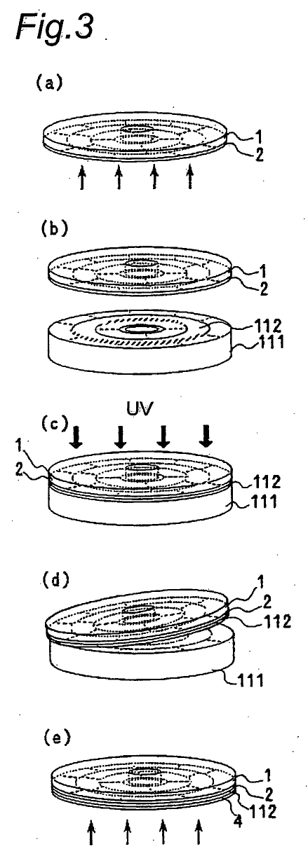

FIG. 3 shows a production method of the optical information recording medium of a single-sided dual-layer structure, which includes a step of forming the optical separating layer by the 2P method. In the step shown in FIG. 3(a), a first information layer 2 is formed on a substrate 1 having a guide groove of a sector structure including sector address portions and data areas. This step is the same as that shown in FIG. 2(a).

The step shown in FIG. 3(b) is a step wherein a transparent resin 112 that is to become the optical separating layer 3 is applied to the stamper 111 having convexities and concavities on its surface. The concavities and convexities on the surface of the stamper 111 are formed depending on the sector structure that is to be formed in the second information layer. The transparent resin layer 112 may be, for example, a UV-curable resin.

The step shown in FIG. 3(c) is a step of bonding the first substrate 1 having the first information layer 2 to the resin layer 112, the layer 2 being opposed to the stamper 111. This step may be carried out according to a preliminary positioning which has been made so that the sector address portions of one information layer does not overlap with those of the other information layer. In this method, the positions of the sector address portions of the second information layer are determined based on the convexities and the concavities of the stamper. More specifically, the bonding step may be carried out by moving horizontally one of the stamper 111 and the first substrate 1 having the first information layer 2 formed thereon after they have been opposed to each other so as to satisfy the positional relationship wherein the sector address portions of one information layer does not overlap with those of the other information layer. Alternatively, the positioning may be carried out on site by rotating the stamper 111 and/or the first substrate 1. Further, in this step, rotation and/or pressurization may be optionally conducted so that the distance between the first substrate 1 and the stamper 111 is uniform. Next, the resin layer 112 is hardened by applying an ultraviolet light from the side of the first substrate 1.

The step shown in FIG. 3(d) is a step of removing the first substrate 1 from the stamper 111 at the boundary between the stamper 111 and the resin layer 112. After these steps, the optical separating layer 3 having the concavities and convexities on its surface is formed on the surface of the first information layer 2.

The step shown in FIG. 3(e) is a step of forming a second information layer 4 on the surface of the optical separating layer 3. After this step, a protective substrate 5 is stacked on the second information layer 4.

As a variant of the production method shown in FIG. 3, there is a method wherein the second information layer 4 is firstly formed on a second substrate 2 which is to become the protective substrate 5 and then the optical separating layer 3 is formed on the second information layer 4. This production method makes it possible to finally form the first substrate 1 on the first information layer 2 as a thin film by, for example, a spin coat method. The optical information recording medium wherein the thickness of the first substrate 1 is small is suitable for recording and reproducing information with a laser beam of a short wavelength.

In the optical information recording medium of a single-sided dual-layer structure, each information layer includes, as a recording layer, a thin film whose optical characteristic is changed by absorbing a focused laser beam, the optically changed phase being able to be distinguished by the laser beam 7. The recorded information signals in the recording layer of each information layer is reproduced by applying the laser beam 7 to the first and the second information layers 2 and 4 and detecting change in intensity of reflected light. Upon the reproduction, it is important that the applied laser beam 7 is exactly focused on the information layer to be reproduced. Particularly, the first information layer 2 preferably has a transmittancy in a range of 30% to 80% with respect to the laser beam 7 of a wavelength that is employed upon recording so that a light beam having a sufficient intensity can reach the second information layer 4.

The information is recorded on and reproduced from the second information layer 4 by the laser beam 7 which has passed through the first information layer 2. For this reason, the recording layer constituting the second information layer 4 preferably has a high absorbance with respect to the laser light of a wavelength employed for recordation and has a high reflectance with respect to the laser beam 7 of a wavelength employed for reproduction.

Each element constituting an optical information recording medium of the present invention is more specifically described.

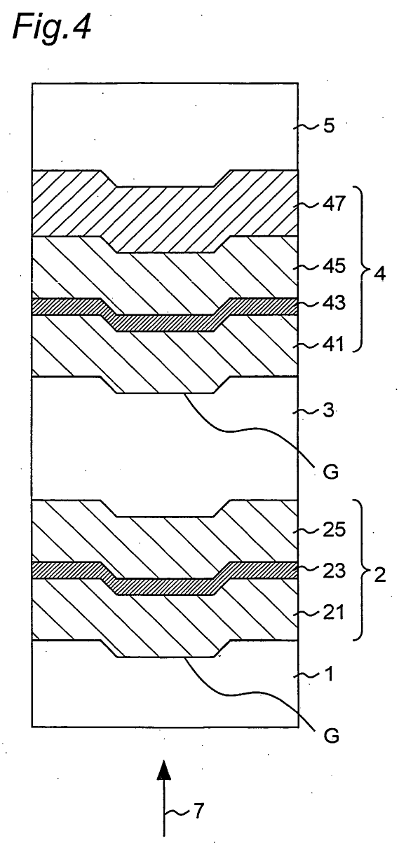

FIG. 4 shows a construction of a first information layer 2 and a second information layer 4 of an optical information recording medium of the present invention in detail. In the medium shown in FIG. 4, the first information layer 2 includes a first recording layer 23 and two protective layers 21 and 25 which protect both surfaces of the layer 23. The second information layer includes a second recording layer 43, two protective layers 41 and 45 which protect both surfaces of the layer 43 and a reflective layer 47. These two information layers 2 and 4 are separated by an optical separating layer 3. In the illustrated embodiment, each of two information layers has a guide groove. In FIG. 4, a face which is nearer to the laser beam 7 is shown as a groove face “G.”

Firstly, a substrate 1 and a protective substrate 5 are described. The substrate 1 is made of a material which is transparent to a wavelength of an applied laser beam. Such materials include a resin such as a polycarbonate and a PMMA, and a glass material. In the surface of the substrate 1 on which the first information layer is formed, address pits constituting the sector address portions 9 are formed and concavities and convexities corresponding to a guide groove as illustrated in FIG. 4 may be formed if necessary. The guide groove is a continuous groove guiding the laser beam 7 and it may be referred to as a “track.” The substrate having the convexities and the concavities may be formed by, for example, applying a mastering process which is employed in a compact disk (CD) and a digital versatile disk (DVD).

The thickness of the substrate 1 may be generally in a range of 0.5 mm to 0.7 mm. When the optical separating layer 3 is formed by the 2P method on the second information layer 4 formed on the second substrate 5, the substrate 1 may be a thin substrate formed by a spin coat method.

The protective substrate 5 may be preferably formed of the same material as that of the substrate 1 and has the same thickness of that of the substrate 1 in order to suppress the curvature of the entire optical information recording medium. The substrate 5, however, does not need to be transparent with respect to a wavelength of the applied laser beam. Also the substrate 5 may be formed by applying a mastering process or may be formed by the spin coat method when the optical separating layer is formed by the 2P method, similarly to the substrate 1.

It is preferable that the materials which constitute the protective layer 21, 25, 41 and 45 are physically and chemically stable. In other words, it is preferable that the materials have melting points and softening temperatures higher than melting points of the materials constituting the first recording layer 23 and the second recording layer 43 and they do not present solid solubility in the material of the recording layer. Further, the protective layers may be preferably transparent with respect to a wavelength of the laser beam. The materials constituting the protective layer includes a material selected from dielectrics such as Al₂O₃, SiO_{X}, Ta₂O₅, MoO₃, WO₃, ZrO₂, ZnS, AlN_{X}, BN, SiN_{X}, TiN, ZrN, PbF₂ and MgF₂, or any combination thereof. When the protective layer is formed of the dielectric, the protective layer may be referred to as a “dielectric layer.” The protective layer, however, does not need to be made of the electric or the transparent material, and it may be formed of a material such as ZnTe which has an optical absorbency with respect to a visible light and an infrared ray. At least one of the illustrated four protective layers 21, 25, 41 and 45 may be formed of a material different from materials of the other protective layers. For example, these four protective layers may be formed of materials different from each other. In that case, there is an advantage that the freedom of disk design in optical and thermal terms is increased. However, four protective layers may be formed of the same material. The protective layer may be formed by a vapor deposition method using an electronic beam, a sputtering method, an ion plating method, a CVD method, or a laser sputtering method.

The thickness of each protective layer may be selected depending on the wavelength(s) of the laser beam which is employed for recordation and reproduction. The thickness of each protective layer may be generally in a range of 20 nm to 200 nm. The protective layers disposed above or below one recording layer are not necessarily of the same thickness, and one of them may be a thin layer while the other may be a thick layer.

The first recording layer 23 and the second recording layer 43 are layers wherein phase change is caused by irradiation of the laser beam and recorded marks are formed. When the phase change is reversible, erasing and rewriting can be carried out. The phase change generally occurs between a crystal phase and an amorphous phase. The phase change may occur between a crystal phase and a crystal phase. The phase change material constituting the recording layer may be, for example, a material whose main component is Te, In or Se. More specifically, the phase change materials include Te-Sb-Ge, Te-Ge, Te-Ge-Sn, Te-Ge-Sn-Au, Sb-Se, Sb-Te, Sb-Se-Te, In-Te, In-Se, In-Se-Tl, In-Sb, In-Sb-Se and In-Se-Te. An experiment which is aimed at finding a material whose overwrite cycle-ability is excellent and determining its material composition shows that a three-element based composition whose main components are Ge, Sb and Te is preferable. When the atomic ratios of these atoms are represented by GeₓSb_{y}Te_{z}, a composition represented by 0.10≦x≦0.35, 0.10≦y, and 0.45≦z≦ 0.65 (herein x+y+z=1) is particularly excellent. The thickness of each recording layer may be, for example, in a range of 10 nm to 15 nm. The recording layer may be formed by a deposition method using an electron beam, a sputtering method, an ion plating method, a CVD method, or a laser sputtering method.

The material of the first recording layer 23 may be the same as or different from the material of the second recording layer 43. Further, the thicknesses of two recording layers may be different from each other. In any case, the material and/or the thickness of the first recording layer 23 are appropriately selected so that the entire first information layer 2 has the transmittancy as described above.

The recording layer formed of a material whose phase changes between the crystal phase and the amorphous phase is generally formed into a film in an amorphous state and may be subjected to an initialization process if necessary. The initialization process is a process in which the temperature of the recording layer in the amorphous state is raised to a temperature more than the crystallization temperature so as to crystallize the layer.

The optical separating layer 3 is an intermediate layer disposed between the first information layer 2 and the second information layer 4. The function of the optical separating layer is as described above. The thickness of the optical separating layer 3 may be generally in a range of 10 μm to 100 μm, and preferably in a range of 30 μm to 60 μm. The optical separating layer 3 is formed of a material transparent with respect to a wavelength of the laser beam which is applied to record signals on the second information layer 4 and to reproduce the recorded signals. This is because a sufficient amount of light is secured at the second information layer 4. The optical separating layer 3 may be formed of, for example, an epoxy-based UV-curable resin. When the optical separating layer 3 is formed by bonding a resin sheet, a two-sided tape for optical disk bonding (for example, a pressure-sensitive adhesive sheet DA-8320 manufactured by NITTO DENKO CORPORATION).

The reflective layer 47 may be made of a metal element selected from Au, Al, Ni, Fe and Cr, or an alloy thereof. The reflective layer 47 is preferably formed since it serves to enhance the optical absorption efficiency of the second recording layer 43. The thickness of the reflective layer 47 may be generally in a range of 50 nm to 180 nm. The reflective layer 47 may be formed by a vapor deposition method using an electron beam, a sputtering method, an ion plating method, a CVD method, or a laser sputtering method.

The reflective layer 47 is formed on a surface of a substrate that is to become the protective substrate 5 when the optical information recording medium is produced by bonding two information layers formed on two substrates together. In that case, on a surface of this reflective layer, the protective layer 45, the recording layer 43 and the protective layer 41 which constitute the second information layer are formed in this order. As shown in FIG. 3, when the optical separating layer 3 is formed by the 2P method, the reflective layer 47 is formed on the protective layer 45.

In the above, an example of an embodiment of a single-sided dual-layer optical information recording medium is described. The optical information medium may further include another layer if necessary. For example, in an embodiment shown in FIG. 4, an interface layer may be formed between each protective layer and each recording layer. The interface layer may be provided so as to prevent mutual element diffusion between the protective layer and the recording layer. The interface layer may be, for example, a nitride or a carbide, for example, a material represented by a general formula of X—N or X—O—N wherein “X” is one element that is preferably selected from Ge, Cr, Si, Al and Te.

Further, a reflective layer may be formed in the first information layer. This reflective layer may be formed adjusting its material and its thickness so that the entire first information layer has the transmittancy as described above.

The optical information recording medium of the present invention is no limited to the single-sided dual-layer structure wherein “n”=2, and it may have three or more information layers. When the optical information recording medium has three or more information layers, the object of the present invention can be achieved by disposing each sector address portion so as not to overlap with other sector address portions of at least adjacent information layer(s) in the direction of stack of information layers. The optical information recording medium of the present invention having three or more information layers may be produced by, for example, repeating the step of forming the optical separating layer by the 2P method as described above and the step of forming the information layer on the surface of the optical separating layer. In that case, each optical separating layer should be formed on the surface of the information layer by locating the substrate on which the information layer is formed and/or the stamper so that the sector address portions of each information layer do not overlap with the sector address portions of the adjacent information layer(s).

The optical information recording medium of the present invention may be constructed as, for example, a medium on and from which information is recorded and reproduced using a red laser beam with a wavelength of about 660 nm, by appropriately selecting the construction of each information layer, the thickness of the optical separating layer and the thickness of the substrate. Alternatively, the optical information recording medium of the present invention may be constructed as, for example, a medium on and from which information is recorded and reproduced using a blue-violet laser beam with a wavelength of about 405 nm. It should be noted that this invention is not limited by the wavelength of the laser beam that is employed for recordation and reproduction and this invention can be applied to any optical information recording medium of a single-sided multi-layer structure having a sector structure.

### INDUSTRIAL APPLICABILITY

The present invention gives an optical information recording medium of a single-sided multi-layer structure from which signals of sector address portions can be reproduced stably, and thus the present invention is preferably applied to a large-capacity optical disk for recording long-time moving image and sound.

1. A single-sided multi-layer optical information recording medium comprising “n” (n≧2) information layers which are formed on a substrate and on and from which a signal can be recorded and reproduced by a laser beam that is applied through the substrate,
wherein an optical separating layer is formed between the information layers, each of the “n” information layers has a sector structure having sector address portions and data areas for recording information signals, the sector address portion and the data area are divided in a circumferential direction, and the sector address portions of each information layer do not overlap with at least the sector address portions of the adjacent information layer(s) in a direction of stack of information layers.

2. The optical information recording medium according to claim 1, wherein the sector address portions of each information layer do not overlap with sector address portions of any other information layers in the direction of stack of information layers.

3. The optical information recording medium according to claim 1, wherein “n”=2.

4. A method for producing an optical information recording medium comprising “n” (n≧2) information layers which are formed on a substrate and on and from which layers a signal can be recorded and reproduced by a laser beam that is applied through the substrate, which comprises:
forming the information layer which has a sector structure having sector address portions and data areas for recording information signals, the sector address portion and the data area being divided in a circumferential direction;
forming an optical separating layer which is to be disposed between the information layers; and
positioning the sector address portions of each information layer so that they do not overlap with at least the sector address portions of the information layer(s). that is adjacent to the each information layer in a direction of stack of information layers.
